(19) United States
(12) Patent Application Publication
(10) Pub. No.: US 2026/0358815 A1
(43) Pub. Date: Nov. 12, 2026

(54) CONTACT DETECTOR, SNOW REMOVAL ROBOT, AND METHOD FOR OBSTACLE AVOIDANCE CONTROL

(71) Applicant: SHENZHEN HANYANG TECHNOLOGY CO., LTD., Shenzhen (CN)

(72) Inventors: Taotao ZHU, Shenzhen (CN); Yongqi SONG, Shenzhen (CN); Hanfeng WEI, Shenzhen (CN); Hang TIAN, Shenzhen (CN); Yixuan CHEN, Shenzhen (CN)

(21) Appl. No.: 19/735,484

(22) Filed: Jul. 8, 2026

Related U.S. Application Data
(63) Continuation of application No. PCT/CN2023/126011, filed on Oct. 23, 2023.
(63) Continuation of application No. 19/004,231, filed on Dec. 28, 2024.
Application No. 19/004,231 is a continuation of application No. PCT/CN2023/126012, filed on Oct. 23, 2023.

(30) Foreign Application Priority Data
Jul. 13, 2023 (CN) 202310863002.2
Jul. 13, 2023 (CN) 202321845307.2
Jul. 13, 2023 (CN) 202321846438.2
Jul. 13, 2023 (CN) 202321853491.5
Jul. 13, 2023 (CN) 202321853681.7
Jul. 13, 2023 (CN) 202321856376.3

(51) Int. Cl. G05D 1/622; E01H 5/09; G01S 13/931; G05D 1/241; G05D 105/00

(52) U.S. Cl. CPC G05D 1/622; E01H 5/098; G01S 13/931; G05D 1/241; G05D 2105/12

(57) ABSTRACT

The present disclosure relates to a contact detector, a snow removal robot, and a method for obstacle avoidance control. The contact detector is configured to be connected to a robot body of the snow removal robot. The contact detector includes a support component, a stationary contact component, and a movable contact component. The support component is disposed on the robot body. The stationary contact component and the movable contact component are disposed on the support component. The movable contact component and the stationary contact component are spaced apart from each other. The movable contact component is configured to move toward the stationary contact component under an external force to be electrically connected to the stationary contact component. When the external force exerted on the support component is removed, the movable contact component is configured to move away from the stationary contact component and break the electrical connection with the stationary contact component. The contact detector triggers a contact obstacle avoidance circuit through direct physical contact, under the external force, of the stationary contact component and the movable contact component. Thus, an alarm may be triggered in time when the contact detector collides with an obstacle, dependence on electromagnetic waves may be reduced, stability of the contact detector may be improved, and an obstacle avoidance ability may be more reliable in a case of a complex work environment such as bad weather.

### CROSS-REFERENCE TO RELATED APPLICATIONS

The present patent document is a continuation of and claims priority to and the benefits of PCT Application No. PCT/CN2023/126011 filed on Oct. 23, 2023, and U.S. application Ser. No. 19/004,231 filed Dec. 28, 2024, which further claims priority to and the benefits of PCT Application No. PCT/CN2023/126012 filed on Oct. 23, 2023, the contents of each of which are hereby incorporated by reference.

The present patent document claims priority to Chinese Patent Application No. CN202310863002.2 filed on Jul. 13, 2023, the contents of which are hereby incorporated by reference.

The present patent document claims priority to Chinese Patent Application Nos. CN202321853491.5 and CN202321846438.2, both filed on Jul. 13, 2023, the contents of each of which are hereby incorporated by reference.

The present patent document claims priority to Chinese Patent Application No. CN202321845307.2 filed on Jul. 13, 2023, the contents of which are hereby incorporated by reference.

The present patent document claims priority to Chinese Patent Application No. CN202321856376.3 filed on Jul. 13, 2023, the contents of which are hereby incorporated by reference.

The present patent document claims priority to Chinese Patent Application No. CN202321853681.7 filed on Jul. 13, 2023, the contents of which are hereby incorporated by reference.

### TECHNICAL FIELD

The present disclosure generally relates to the technical field of robots, and in particular, to a contact detector, a snow removal robot, and a method for obstacle avoidance control.

### BACKGROUND

A snow removal robot, a type of yard robot, may include a snow sweeping implement and a self-propelled apparatus used to drag the snow sweeping implement to move in a yard. The self-propelled apparatus usually includes a wheeled or crawler-type vehicle body, and the snow sweeping implement mainly includes a snow collection implement and a snow throwing implement. The snow collection implement collects snow on the ground into a snow collection bin, and then throws, through the snow throwing implement, the snow in the snow collection bin in a specified direction.

In order to implement an automatic snow cleaning function, a travel path of the snow removal robot usually needs to be preset, and the snow removal robot travels along the set track when sweeping the snow. However, when an obstacle appears on the travel track, the snow removal robot may continue moving by bypassing the obstacle through an obstacle avoidance system. However, the obstacle avoidance systems of existing snow removal robots are often limited and may lack stability. The entire apparatus may potentially fail once the systems fail.

### SUMMARY

Some embodiments of the present disclosure may provide a contact detector, a snow removal robot, and a method for obstacle avoidance control.

In a first aspect, some embodiments of the present disclosure provide a contact detector. The contact detector is configured for use with a snow removal robot, where the snow removal robot includes a working portion of a robot body, the contact detector is adapted to be connected to the robot body, and the contact detector includes a support component, a stationary contact component, and a movable contact component; the support component may be arranged at a periphery of the working portion of the robot body, the stationary contact component may be disposed on the support component, and the movable contact component may be disposed on the support component; the movable contact component and the stationary contact component are spaced apart from each other, and the movable contact component is configured to move toward the stationary contact component under an external force to be electrically connected to the stationary contact component; and when the external force exerted on the support component is removed, the movable contact component is configured to separate from the stationary contact component and break the electrical connection with the stationary contact component.

In a second aspect, some embodiments of the present disclosure further provide a contact detection device. The contact detection device may include the contact detector described above and a contact obstacle avoidance circuit, where the contact obstacle avoidance circuit may be arranged at a robot body, the contact obstacle avoidance circuit may be electrically connected to the movable contact component and the stationary contact component, and in a case where the support component is subjected to external force, the movable contact component is electrically connected to the stationary contact component, to close the contact obstacle avoidance circuit.

In a third aspect, some embodiments of the present disclosure further provide an obstacle avoidance system. The obstacle avoidance system may include the contact detection device described above, a remote sensing detection device, and a controller, where the remote sensing detection device may be arranged at a side, oriented towards a forward direction of a snow removal robot, of a robot body; and the controller may be arranged at the robot body, and the controller may be configured to control the snow removal robot to adjust a movement path according to detection signals of the contact detection device and the remote sensing detection device.

In a fourth aspect, some embodiments of the present disclosure further provide a snow removal robot. The snow removal robot may include a robot body and an obstacle avoidance system, where the robot body is used to remove snow from a road; and the obstacle avoidance system may be arranged at the robot body.

In a fifth aspect, some embodiments of the present disclosure further provide a method for obstacle avoidance control. The method for obstacle avoidance control may be applied to the snow removal robot described above. The method for obstacle avoidance control may include: receiving a detection signal from a sensor, where the sensor includes contact detectors, a plurality of contact detectors are arranged in correspondence to different orientations, and the detection signal includes collision signals sent by the contact detectors; retrieving sensor information corresponding to the contact detectors from the detection signal, where the sensor information includes identity tags uniquely corresponding to the contact detectors; and outputting an obstacle avoidance instruction associated with the respective identity tags.

In a sixth aspect, some embodiments of the present disclosure further provide a snow removal robot. The snow removal robot may include a robot body, an obstacle avoidance system, one or more processors, and a memory, where the robot body is used to remove snow from a road; the obstacle avoidance system may be arranged at the robot body; and the one or more programs are stored in the memory and are configured to be executed by the one or more processors, and the one or more programs are configured to perform the method described above.

The embodiments of the present disclosure provide the contact detector. The contact detector may trigger the contact obstacle avoidance circuit through direct physical contact, under the external force, of the stationary contact component and the movable contact component. Thus, an alarm may be triggered in time when the contact detector collides with an obstacle, dependence on electromagnetic waves may also be reduced, stability of the contact detector may be improved, and an obstacle avoidance ability may be more reliable in a case of a complex work environment such as bad weather.

### BRIEF DESCRIPTION OF DRAWINGS

To more clearly describe the technical solutions of some embodiments of the present disclosure, accompanying drawings required in the description of the embodiments will be briefly described below. It should be understood that the accompanying drawings in the following description merely show some embodiments of the present disclosure, and those of ordinary skill in the art may still derive other accompanying drawings from these accompanying drawings without undue experimentation.

FIG. 1 illustrates a schematic structural view of a snow removal robot in accordance with one or more embodiments of the present disclosure;

FIG. 2 illustrates a schematic structural view of the snow removal robot shown in FIG. 1, where an anti-collision frame is lower than a remote sensing detection device;

FIG. 3 illustrates a schematic structural view of a support component of the snow removal robot shown in FIG. 1;

FIG. 4 illustrates a schematic structural view of a contact detection device of the snow removal robot shown in FIG. 1;

FIG. 5 illustrates an exploded view of the anti-collision frame and the support component of the snow removal robot shown in FIG. 1;

FIG. 6 illustrates an exploded view of the anti-collision frame and the support component of the snow removal robot shown in FIG. 1 from another angle;

FIG. 7 illustrates a schematic structural view of an alignment recess of the support component of the snow removal robot shown in FIG. 1;

FIG. 8 illustrates a schematic structural view of a buffer cavity of the support component of the snow removal robot shown in FIG. 1; and

FIG. 9 illustrates a flowchart of a method for obstacle avoidance control in accordance with one or more embodiments of the present disclosure.

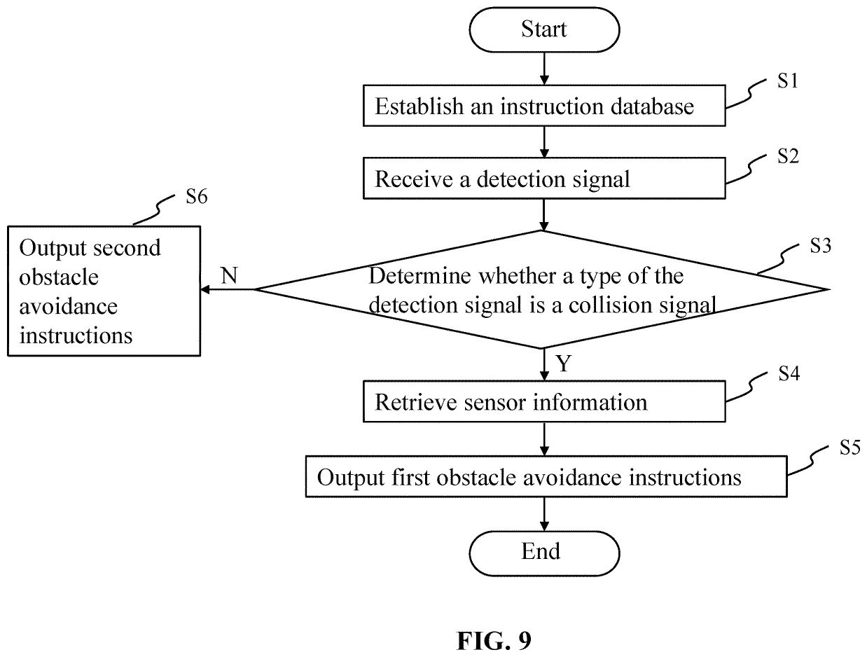

### BRIEF DESCRIPTION OF THE DRAWINGS

1000. snow removal robot; 100. robot body; 10. working portion; 200. obstacle avoidance system; 300. snow shield; 400. contact detection device; 500. remote sensing detection device; 600. contact detector; 610. support component; 611. stationary support portion; 6111. alignment recess; 612. movable support portion; 613. elastic return portion; 614. deformation space; 615. buffer cavity; 616. connection portion; 617. auxiliary recess; 6171. first extension surface; 6172. second extension surface; 618. second matching portion; 6181. snap-in protrusion; 620. stationary contact component; 621. stationary contact conductor; 622. stationary contact covering; 630. movable contact component; 631. movable contact conductor; 632. movable contact covering; 640. anti-collision frame; 641. anti-collision body portion; 642. anti-collision extension portion; 643. first matching portion; 6431. snap-fit recess; 650. extension frame; 651. mounting position; 660. junction box; 661. wire through hole; and 670. wire organizer.

### Detailed Description

To make the solutions in the present disclosure to be better understood by those of ordinary skill in the art, the technical solutions in the embodiments of the present disclosure will be clearly and completely described below with reference to the accompanying drawings in the embodiments of the present disclosure. It should be understood that the described embodiments are merely some embodiments rather than all embodiments of the present disclosure. All other embodiments derived by those of ordinary skill in the art from the embodiments of the present disclosure without undue experimentation should fall within the protection scope of the present disclosure.

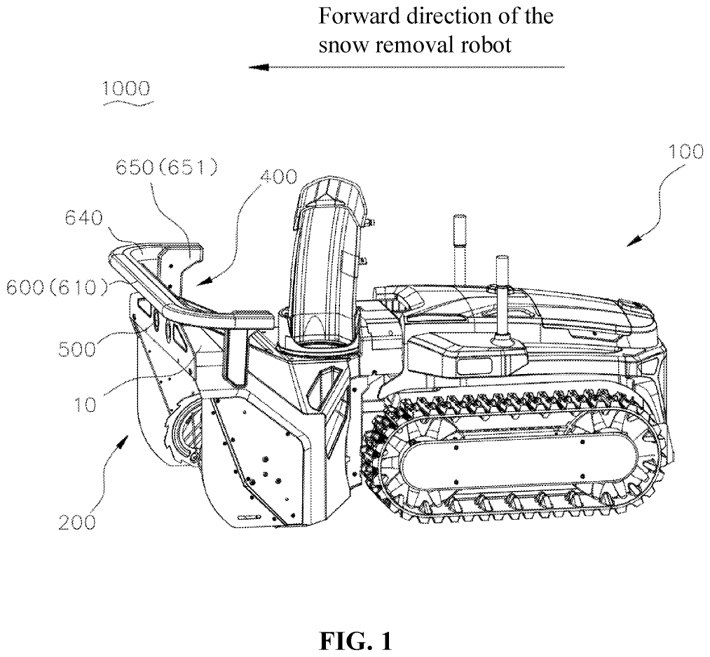

With reference to FIG. 1, a snow removal robot 1000 in the present disclosure may include a robot body 100 and a self-propelled apparatus for dragging the robot body 100 to move. The robot body 100 may include a working portion 10, and the working portion 10 may be configured to remove snow from ground and throw the snow away from the road. The self-propelled apparatus may be configured to drive the robot body 100 to move, such as forward, reverse, and turning. The self-propelled apparatus may adopt a crawler or a wheel mode, which is not limited specifically in these embodiments. In such embodiments, an obstacle avoidance system 200 is integrated on the robot body 100. The obstacle avoidance system 200 may adjust a movement path of the snow removal robot 1000 according to a signal (such as a light signal and a radar echo signal) reflected by an obstacle, to avoid the robot body 100 colliding with the obstacle.

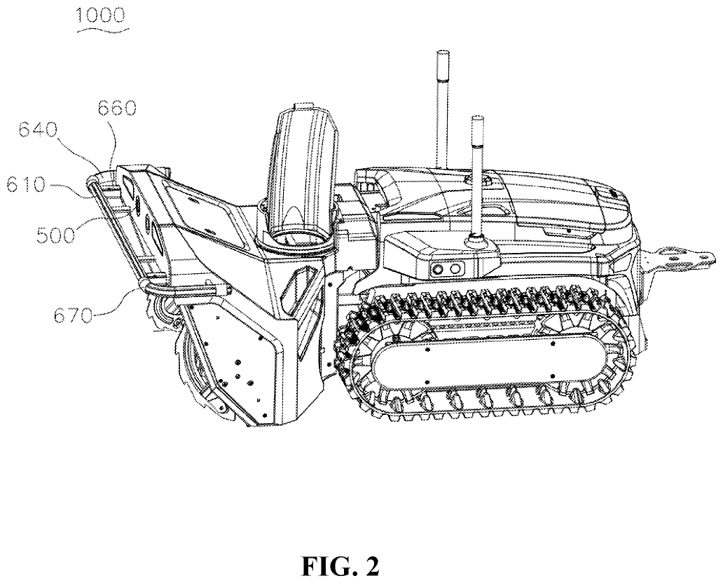

With reference to FIG. 1 and FIG. 2, the obstacle avoidance system 200 in these embodiments may include a contact detection device 400, a remote sensing detection device 500, and a controller. The controller may be electrically connected to the contact detection device 400 and the remote sensing detection device 500, to transmit the signal. The remote sensing detection device 500 may be arranged at one side surface or more side surfaces of the working portion 10 of the robot body 100, for example, at a side, oriented towards a forward direction of the snow removal robot 1000, of the working portion 10, for detecting the obstacle. The remote sensing detection device 500 may include at least one signal receiver for receiving the signal reflected by a surface of the obstacle. The remote sensing detection device 500 may detect, through a transmission medium such as a signal wave, the obstacle encountered by the robot body 100 in a process of travel, and may transmit the signal to the controller for computation of the controller. The contact detection device 400 may be connected to the robot body 100 through a mechanical structure. The contact detection device 400 transmits detection information of the obstacle to the controller through changes of a physical structure and shape, which is more direct and specific.

With reference to FIG. 1 and FIG. 2, in such embodiments, the contact detection device 400 and the remote sensing detection device 500 are simultaneously disposed on the robot body 100, to jointly detect the obstacle. In addition, a position of the contact detection device 400 and a position of the remote sensing detection device 500 are adaptively adjusted, such that the contact detection device and the remote sensing detection device are enabled to effectively detect the obstacle.

Specifically, these embodiments may have a structure of an anti-collision frame 640, and the anti-collision frame 640 may be connected to the working portion 10 of the robot body 100. The anti-collision frame 640 may extend in the forward direction of the snow removal robot 1000 relative to the robot body 100. That is, in the forward direction of the snow removal robot 1000, the anti-collision frame 640 is located in the front of the robot body 100. When the obstacle is encountered, the anti-collision frame 640 may collide with the obstacle before the robot body 100. Thus, impact of the obstacle on the robot body 100 may be reduced, and a structure of the robot body 100 may be protected. It may be further understood that the contact detection device 400 and the remote sensing detection device 500 may be arranged at an interval in the forward direction of the snow removal robot 1000, and the contact detection device 400 is located at a front side of the remote sensing detection device 500.

With reference to FIG. 1, the contact detection device 400 may be laterally offset from a signal receiving path of a signal receiver of the remote sensing detection device 500. That is, the anti-collision frame 640 in the contact detection device 400 is laterally offset from the signal receiving path of the signal receiver of the remote sensing detection device 500, to ensure accuracy of a detection signal of the remote sensing detection device 500. As an example, in a vertical direction, a height of the anti-collision frame 640 of the contact detection device 400 in these embodiments is greater than a height of the remote sensing detection device 500, and it may be considered that the anti-collision frame 640, that is, the contact detection device 400 is arranged above the remote sensing detection device 500. Specifically, in a projection along the forward direction of the snow removal robot 1000, a projected contour of the anti-collision frame 640 and a projected contour of the remote sensing detection device 500 are spaced apart from each other. The projected contour of the anti-collision frame 640 is located on a side of the projected contour of the remote sensing detection device 500 facing away from ground. That is, in a vertical direction, the anti-collision frame 640, that is, the contact detection device 400 is higher than the remote sensing detection device 500, such that the case that the structure such as the anti-collision frame 640 hinders the remote sensing detection device 500 from detecting the obstacle on the ground may be avoided.

With reference to FIG. 2, in some embodiments, the height of the anti-collision frame 640 is lower than the height of the remote sensing detection device 500. Specifically, in a projection along the forward direction of the snow removal robot 1000, a projected contour of the anti-collision frame 640 and a projected contour of the remote sensing detection device 500 are spaced apart from each other. The projected contour of the anti-collision frame 640 is located at a side, closest to ground, of the projected contour of the remote sensing detection device 500. That is, in a vertical direction, the anti-collision frame 640, that is, the contact detection device 400 is lower than the remote sensing detection device 500. When there is the obstacle on the ground, the contact detection device 400 may detect the obstacle before the remote sensing detection device 500. By setting a distance between the anti-collision frame 640 and the robot body 100, the robot body 100 may keep a safe distance from the obstacle. Thus, a structure used for shoveling and throwing snow on the robot body 100 may be protected, the robot body 100 may have sufficient activity space to adjust a moving direction of the robot body 100, and the robot body 100 may be prevented from rubbing against the obstacle when rotating.

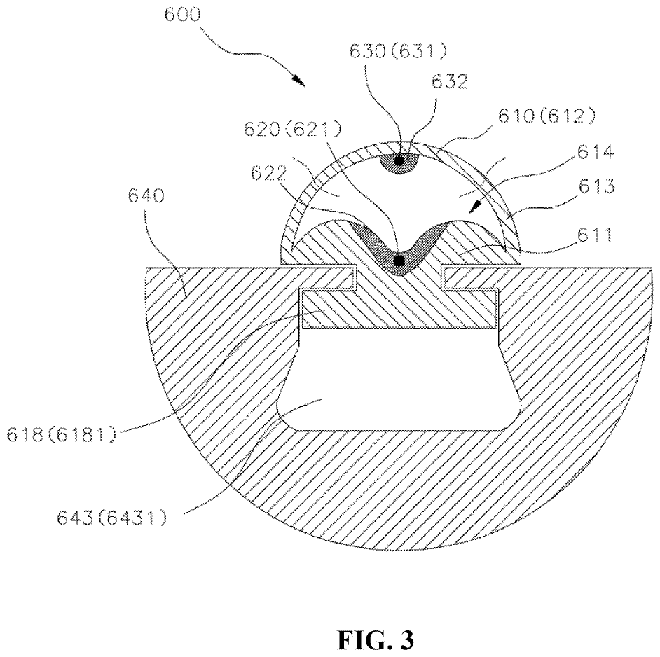

With reference to FIG. 1, FIG. 2, and FIG. 3, the contact detection device 400 in these embodiments may include a contact detector 600 and a contact obstacle avoidance circuit. The contact detector 600 may be disposed on the working portion 10 of the robot body 100 for detecting an orientation of the obstacle through contact measurement. The contact detector 600 in these embodiments may include a support component 610, a movable contact component 630, and a stationary contact component 620. The support component 610 may be arranged at the working portion 10 of the robot body 100. The support component 610 may be located at a periphery of an outer side of the working portion 10. The stationary contact component 620 and the movable contact component 630 are spaced apart from each other at the support component 610, and the stationary contact component 620 and the movable contact component 630 are in conductive structures. The stationary contact component 620 and the movable contact component 630 may be connected to each other, to close the contact obstacle avoidance circuit. A mechanism by which the stationary contact component 620 and the movable contact component 630 close or open the contact obstacle avoidance circuit is that in an initial state, the movable contact component 630 and the stationary contact component 620 are arranged at an interval. The movable contact component 630 is subjected to external force and moves in a direction toward the stationary contact component 620 until the movable contact component is electrically connected to the stationary contact component 620. After the stationary contact component 620 is in contact connection to the movable contact component 630, the contact obstacle avoidance circuit is closed. Thus, the self-propelled apparatus may be controlled to adjust the movement path of the snow removal robot 1000, the snow removal robot 1000 may be prevented from stopping at a position where the snow removal robot encounters the obstacle, and the snow removal robot 1000 may continue working. When the external force exerted on the support component 610 is removed, the movable contact component 630 moves in a direction away from the stationary contact component 620, and breaks an electrical connection with the stationary contact component 620. The movable contact component 630 and the stationary contact component 620 are restored to the initial state of being arranged at an interval, and are electrically disconnected, thereby opening the contact obstacle avoidance circuit.

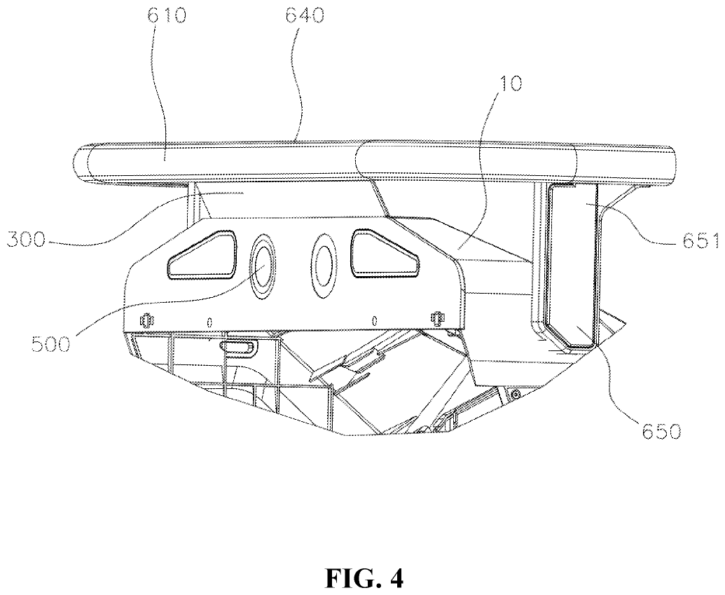

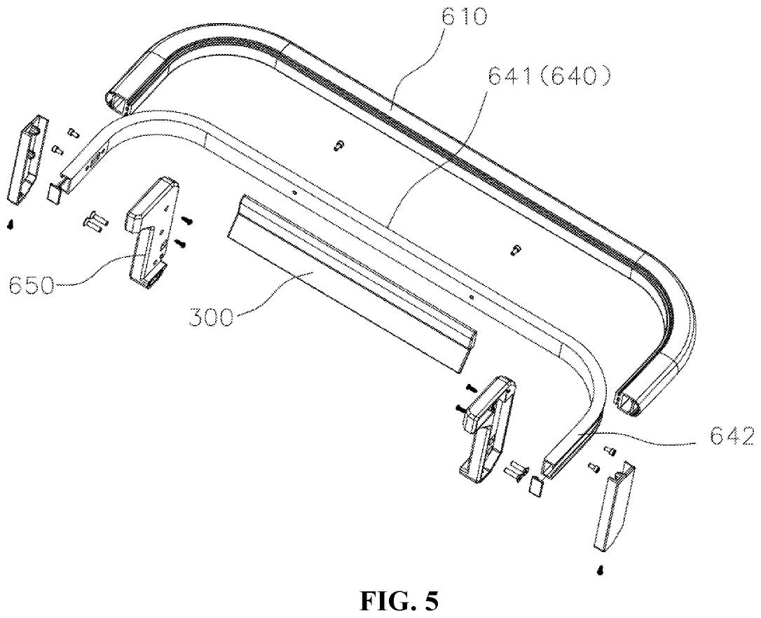

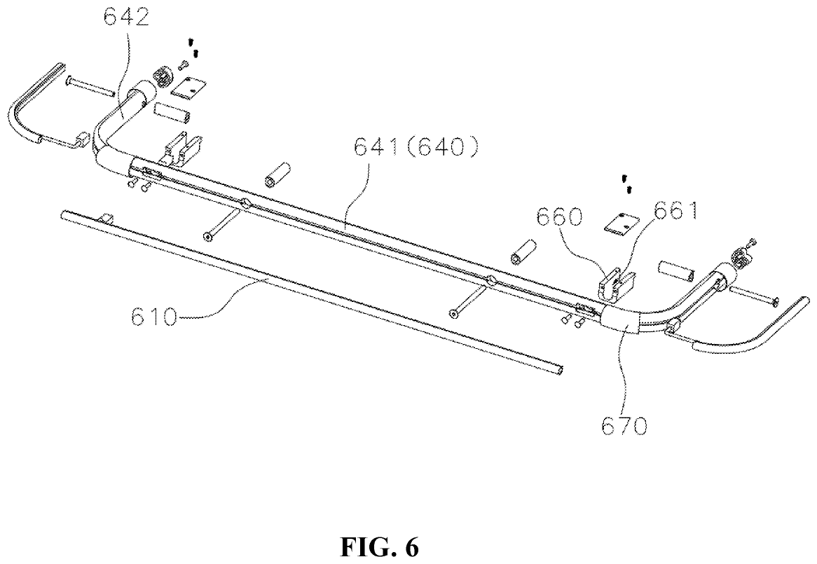

With reference to FIG. 4, FIG. 5, and FIG. 6, in some embodiments, the support component 610, the movable contact component 630, and the stationary contact component 620 may be strip structures, an extension direction of the support component 610 may be arranged to intersect with the forward direction of the snow removal robot 1000, and the support component 610 may extend around an outer contour of the working portion 10. When the snow removal robot 1000 moves forward, the support component 610 may be basically horizontally arranged; for example, the extension direction of the support component 610 may be perpendicular to the forward direction of the snow removal robot 1000, and may extend along a horizontal plane. Thus, a collision detection range of the contact detector 600 is large. The stationary contact component 620 and/or the movable contact component 630 may extend in a length direction of the support component 610. As an example, in some embodiments, the movable contact component 630, the stationary contact component 620, and the support component 610 may be set as elongated flexible components, and any point on the support component 610 may partially deform when colliding. Thus, the stationary contact component 620 and the movable contact component 630 are in contact connection to each other, to trigger the contact obstacle avoidance circuit. With such arrangement, a continuous linear contact detection zone may be formed, higher accuracy may be achieved, and a detection dead angle may be eliminated or reduced. At least one contact detector 600 may be disposed on the robot body 100, that is, the working portion 10, to play a protective role in a case of collision with the obstacle. The contact detector 600 may trigger the obstacle avoidance circuit when in contact with the obstacle, correct a travel track of the snow removal robot 1000, and perform the obstacle avoidance function of parking or obstacle bypassing. As a result, the contact detector 600 in these embodiments may implement the protection function, and may further have an obstacle avoidance effect.

With reference to FIG. 3, the support component 610 in these embodiments may have a tubular structure, and the support component 610 may define a deformation space 614. Specifically, the support component 610 may include a stationary support portion 611 and a movable support portion 612. The movable support portion 612 may be located at a side of the stationary support portion 611, and the movable support portion 612 and the stationary support portion 611 may be arranged side-by-side and spaced apart from each other in the forward direction of the snow removal robot 1000. The stationary contact component 620 may be disposed on the stationary support portion 611, and the movable contact component 630 may be disposed on the movable support portion 612. The support component 610 includes the stationary support portion 611 and the movable support portion 612, and may further include an elastic return portion 613. The elastic return portion 613 may be connected between the movable support portion 612 and the stationary support portion 611. At least one of the movable support portion 612 and the elastic return portion 613 may comprise a structure having elastic deformability. Thus, in a case where the external force is removed, the stationary support portion 611 and the movable support portion 612 may be restored to the initial state of being spaced apart from each other. That is, the movable contact component 630 and the stationary contact component 620 are restored to the initial state of being spaced apart from each other, the electrical connection between the movable contact component and the stationary contact component is broken, and the contact obstacle avoidance circuit is opened. The movable support portion 612 may be arranged in a cambered shape, such that the movable support portion 612 elastically deforms inwards when subjected to the external pressure and generates greater restoring force. By adopting this structure, a requirement for elasticity of the support component 610 may be reduced, the requirement for reset of the movable support portion 612 after removal of the external force is satisfied, and the reset ability of the apparatus is further structurally enhanced. Reliability of products is improved, requirements for production materials are reduced, and production cost is further reduced.

The movable support portion 612, the stationary support portion 611, and the elastic return portion 613 may define a deformation space 614 of the support component 610. In some embodiments, with such arrangement, the support component 610 may have a tubular structure, and the contact detector 600 may form a closed structure as a whole. Thus, the stationary contact conductor 621 included in the stationary contact component 620 and the movable contact conductor 631 included in the movable contact component 630 may be protected, influence of the external environment may be reduced, a failure rate of the apparatus may be reduced, and the service life may be prolonged. The stationary contact conductor 621 and the movable contact conductor 631 may comprise conductive material structures, such as metal wires, and are conductive and may withstand structural deformation. In some embodiments, the movable support portion 612, the stationary support portion 611, and the elastic return portion 613 are integrally formed, and are easy to machine and low in production cost.

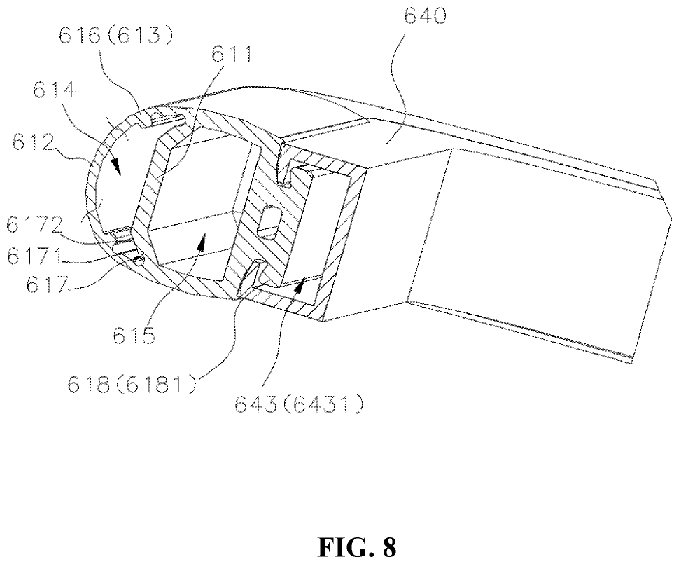

With reference to FIG. 8, in some embodiments, the stationary support portion 611 may also comprise a structure having elastic deformability, and the stationary support portion 611 may define a buffer cavity 615. By arranging the buffer cavity 615, pain caused by accidental touch on a human may be reduced, a buffer distance may be increased, and longer response time may be provided for the obstacle avoidance system 200 to make an obstacle avoidance action. Thus, an obstacle avoidance effect may be improved, and a damage rate of the apparatus may be reduced.

According to the foregoing context, it may be understood that the movable contact conductor 631 may move close to get in contact with and be electrically connected to the stationary contact conductor 621 when the movable support portion 612 is subjected to the external force. In some embodiments, two arrangement methods of the movable contact conductor 631 and the stationary contact conductor 621 may be provided.

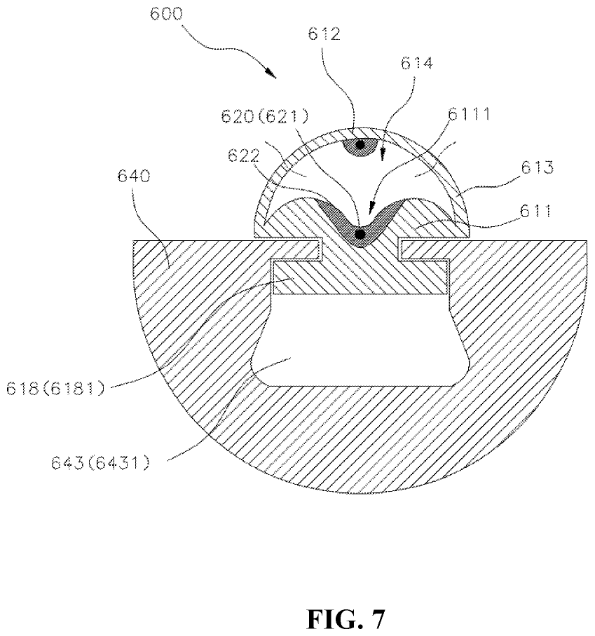

With reference to FIG. 3 and FIG. 7, a side, oriented towards the movable support portion 612, of the stationary support portion 611 may be provided with an alignment recess 6111 having two sides inclined to the center. The stationary contact conductor 621 may be disposed on a center of a bottom of the alignment recess 6111. Specifically, two sides of a surface of the stationary support portion 611 may extend into a tube, to form the alignment recess 6111. The movable contact conductor 631 may be protrudingly disposed on a surface, of a side, oriented towards the stationary support portion 611, of the movable support portion 612, and form a raised structure matching a shape of an inner cavity of the alignment recess 6111. The movable contact conductor 631 and the alignment recess 6111 may be spaced apart from each other. When the movable support portion 612 is subjected to the external force, the movable contact conductor 631 may move toward the stationary contact conductor 621, to be inserted in the alignment recess 6111, to get in contact with and connect to the stationary contact conductor 621. With arrangement of the alignment recess 6111, the movable contact conductor 631 may be guided to slide to the bottom of the alignment recess 6111 when the movable contact conductor 631 moves towards the stationary contact conductor 621. Thus, a probability that the movable contact conductor 631 and the stationary contact conductor 621 are in contact and connection may be increased, and a detection effect of the contact detector 600 may be guaranteed.

With reference to FIG. 3, it may be understood that in order to prevent the movable contact conductor 631 and the stationary contact conductor 621 from falling off the support component 610, the stationary contact component 620 in these embodiments may further include a stationary contact covering 622. The stationary contact covering 622 may cover the surface of the side, oriented towards the movable support portion 612, of the stationary support portion 611 and encapsulate the stationary contact conductor 621. In some embodiments, the movable contact component 630 may further include a movable contact covering 632. The movable contact covering 632 may cover the surface of the side, oriented towards the stationary support portion 611, of the movable support portion 612 and encapsulate the movable contact conductor 631. The stationary contact covering 622 and the movable contact covering 632 may comprise conductive structures. The stationary contact covering 622 and the movable contact covering 632 may prevent the movable contact conductor 631 and the stationary contact conductor 621 from falling off the support component 610, the movable contact conductor 631 and the stationary contact conductor 621 may be fixed more firmly on the support component 610, and the service life of the contact detector 600 may be prolonged. In addition, the possibility of connection between the movable contact conductor 631 and the stationary contact conductor 621 may be improved through the stationary contact covering 622 and the movable contact covering 632 that have conductivity. Thus, the contact obstacle avoidance circuit may be accurately triggered, and an obstacle avoidance function of the obstacle avoidance system 200 may be improved. In addition, the alignment recess 6111 also increases an electrical contact area between the stationary contact covering 622 and the movable contact covering 632. It should also be noted that in order to prevent the contact obstacle avoidance circuit from being closed by mistake, the support component 610 in these embodiments may comprise an electrically insulating structure.

In other embodiments, the stationary contact conductor 621 may be embedded in the stationary support portion 611, the stationary contact conductor 621 may be at least partially located at the surface of the side, oriented towards the movable support portion 612, of the stationary support portion 611, the movable contact conductor 631 may be embedded in the movable support portion 612, and the movable contact conductor 631 may be at least partially located at a surface of a side, oriented towards the stationary support portion 611, of the movable support portion 612. With such arrangement, relationship stability of connections of the movable contact conductor 631 and the stationary contact conductor 621 to the support component 610 may be guaranteed, and the movable contact conductor 631 and the stationary contact conductor 621 are unlikely to fall off from the support component 610. In addition, in order to increase the electrical contact area between the movable contact component 630 and the stationary contact component 620, the stationary contact component 620 in these embodiments may further include the stationary contact covering 622, and the stationary contact covering 622 may cover the surface of the side, oriented towards the movable support portion 612, of the stationary support portion 611 and encapsulate the stationary contact conductor 621. The movable contact component 630 may further include the movable contact covering 632. The movable contact covering 632 may cover the surface of the side, oriented towards the stationary support portion 611, of the movable support portion 612 and encapsulate the movable contact conductor 631. The stationary contact covering 622 and the movable contact covering 632 may comprise conductive structures.

With reference to FIG. 7, in some embodiments, the support component 610 further may include a connection portion 616, the connection portion 616 may be connected between the movable support portion 612 and the stationary support portion 611, and a joint between the connection portion 616 and the stationary support portion 611 may be recessed in a direction facing away from the movable support portion 612 and may form an auxiliary recess 617. The auxiliary recess 617 may have two opposite recess walls, and the surfaces of the two opposite recess walls of the auxiliary recess 617 are defined as a first extension surface 6171 and a second extension surface 6172 respectively. The movable contact covering 632 may extend towards the auxiliary recess 617 and cover the first extension surface 6171. The stationary contact covering 622 may extend towards the auxiliary recess 617 and cover the second extension surface 6172. With arrangement of the auxiliary recess 617, sensitivity of the movable support portion 612 may be improved, and the movable support portion 612 may deform when subjected to small external force. Through the cooperation of the auxiliary recess 617 with the movable contact covering 632 and the stationary contact covering 622, the contact obstacle avoidance circuit may be triggered by small external force, and the forward direction of the snow removal robot 1000 may be adjusted when the support component 610 just touches the obstacle. Thus, the obstacle avoidance effect of the contact detector 600 may be improved.

With reference to FIG. 1, FIG. 2, and FIG. 5, in order to mount the support component 610 at the working portion 10 of the robot body 100, the contact detector 600 in these embodiments further may include an anti-collision frame 640. The anti-collision frame 640 may be adapted to be connected to the robot body 100, that is, the working portion 10. The support component 610 may be disposed on the anti-collision frame 640. The anti-collision frame 640 and the robot body 100 may be spaced apart from each other horizontally and the anti-collision frame may be located at a side of the robot body 100. The anti-collision frame 640 may play a protective role in a case of collision with the obstacle, may support the stationary support portion 611 to prevent the stationary support portion 611 from deforming, and may prevent the contact detector 600 from generating an error signal.

With reference to FIG. 1, FIG. 2, and FIG. 5, it may be seen from the foregoing context that the support component 610 in these embodiments may have a strip structure. The anti-collision frame 640 in these embodiments may also have a strip structure and may extend around at least a portion of a perimeter of the robot body 100. Specifically, the anti-collision frame 640 may include an anti-collision body portion 641 and two anti-collision extension portions 642. The two anti-collision extension portions 642 may be connected to two ends, in a length direction, of the anti-collision body portion 641 respectively, each anti-collision extension portion 642 may be bent relative to the anti-collision body portion 641, and the two anti-collision extension portions 642 may be spaced apart from each other. The support component 610 may be configured to match the anti-collision frame 640, and may be located on a side of the anti-collision frame 640 facing away from the working portion 10. Two end portions of the support component 610 in a length direction may extend along a same side, and the support component 610 may be disposed on the anti-collision body portion 641 and the two anti-collision extension portions 642 in turn.

In order to prevent the support component 610 from falling off the anti-collision frame 640, the contact detector 600 in these embodiments may further include a wire organizer 670. The wire organizer 670 may surround a periphery of the anti-collision frame 640 and the support component 610, to tighten the anti-collision frame 640 and the support component 610. If the anti-collision body portion 641 is disposed on a front of the robot body 100, the two anti-collision extension portions 642 may be located at two side portions, relative to the front of the robot body 100, of the robot body 100 respectively. Thus, a probability that the support component 610 touches the obstacle may be improved, and the detection effect may be improved.

With reference to FIG. 7 and FIG. 8, in some embodiments, the support component 610 and the anti-collision frame 640 may be bonded or connected by a matching component. In some embodiments, the matching component may include a first matching portion 643 disposed on the anti-collision frame 640 and a second matching portion 618 disposed on the support component 610. The second matching portion 618 may include a snap-in protrusion 6181 disposed on a side of the stationary support portion 611 facing away from the movable support portion 612. The first matching portion 643 may include a snap-fit recess 6431 provided in the anti-collision frame 640. The snap-in protrusion 6181 may be opposite the snap-fit recess 6431, and the snap-in protrusion 6181 may cooperate with the snap-fit recess 6431 to be connected. In some embodiments, the support component 610 may be fixedly connected to the anti-collision frame 640 through the snap-in protrusion 6181 and the snap-fit recess 6431. Thus, rapid disassembly and assembly may be implemented, and assembly and maintenance of the contact detector 600 may be facilitated. Specifically, the snap-in protrusion 6181 may be disposed at a bottom of the support component 610. In some embodiments, the snap-in protrusion and the support component are integrally formed. In other embodiments, the snap-in protrusion 6181 and the support component 610 may alternatively be in a split structure, and are fixedly connected into a whole through assembly.

With reference to FIG. 1, FIG. 4, and FIG. 5, as mentioned above, the anti-collision frame 640 is disposed at a position higher than the remote sensing detection device 500. In order to implement this position arrangement, the contact detector 600 in these embodiments may further include an extension frame 650 extending in a vertical direction, and the extension frame 650 may be adapted to be connected to the working portion 10 of the robot body 100. The extension frame 650 may be configured to support the anti-collision frame 640, to cause the anti-collision frame 640 to avoid a detection path of the remote sensing detection device 500 of the snow removal robot 1000. Specifically, a top of the extension frame 650 may be provided with a mounting position 651, and the anti-collision frame 640 may be mounted on the mounting position 651. Since a work environment of the snow removal robot 1000 may determine that the obstacles encountered are usually located on the ground, and an effective detection range is mainly concentrated on the ground in front of a travel path. In some embodiments of the present disclosure, by arranging the extension frame 650, the anti-collision frame 640 and the support component 610, that is, the contact detection device 400, may be arranged above the remote sensing detection device 500, to prevent the detection path on the ground of the remote sensing detection device 500 from being partially blocked by the anti-collision frame 640 and the support component 610. The remote sensing detection device 500 may have no dead angle in detecting the obstacle on the ground, and obstacle avoidance accuracy of the apparatus may be improved. The extension frame 650 in these embodiments may be hollow, and a channel for wiring of the support component 610 may be provided in the extension frame. Thus, wires may be extended between the support component 610 and the robot body 100 and protected.

With reference to FIG. 6, further, in order to improve convenience of the wiring of the snow removal robot 1000, in addition to the hollow extension frame 650, the contact detector 600 in these embodiments may further include a junction box 660. The junction box 660 may be connected between the anti-collision frame 640 and the working portion 10 of the robot body 100, and the junction box 660 may be provided with a wire through hole 661. The wire through hole 661 may penetrate two opposite end faces of the junction box 660, and two ports of the wire through hole 661 may be connected to an interior of the anti-collision frame 640 and an interior of the robot body 100 respectively. Thus, wires may be connected to the stationary contact conductor 621 and the movable contact conductor 631 in the support component 610, and a control circuit board inside the robot body 100 without being exposed.

With reference to FIG. 1, in some embodiments, the anti-collision frame 640 may protrude from the remote sensing detection device 500 in a horizontal direction. Since the remote sensing detection device 500 may include a signal receiver, the signal receiver includes one or a combination of more the following: a laser radar, a millimeter wave radar, a camera, and an ultrasonic radar. These types of signal receivers may be extremely sensitive to external collision. In some embodiments, the anti-collision frame 640 may be arranged to protrude from the remote sensing detection device 500 in the horizontal direction. In a case of collision with the obstacle, the anti-collision frame 640 may get in contact with the obstacle at first, the remote sensing detection device 500 may be protected, the remote sensing detection device 500 may be prevented from being damaged due to collision, and the service life of the apparatus may be prolonged.

In addition, the snow removal robot 1000 in these embodiments may further include a snow shield 300, and the snow shield 300 may be connected to the anti-collision frame 640. Since the anti-collision frame 640 may be located above the remote sensing detection device 500, the snow shield 300 may be located above the remote sensing detection device 500, to reduce a probability of snow adhering to the remote sensing detection device 500. Specifically, the snow shield 300 may have two opposite side portions, one of the side portions may be connected to the anti-collision frame 640, and the other of the two side portions may be connected to the working portion 10 of the robot body 100. The snow may be prevented from seeping down from a gap between the snow shield 300 and the working portion 10 and polluting the remote sensing detection device 500 or affecting the detection function of the remote sensing detection device 500. The snow shield 300 may be made of a transparent material, may allow light to pass through, and may avoid affecting a lighting effect of the camera. The snow shield 300 may prevent the camera from being damaged due to being hit, and may also shield dust and snow, avoid corrosion caused by pollution of a lens of the camera, and play a protective effect of isolation from the outside. In addition, in some embodiments, the snow shield 300 may be arranged above the remote sensing detection device 500, the structure of the snow shield 300 may be laterally offset from the signal receiving path of the remote sensing detection device 500, and the structure of the snow shield 300 may be prevented from blocking the detection path of the remote sensing detection device 500.

Based on the snow removal robot, these embodiments also may provide a method for obstacle avoidance control. The method may be applied to the snow removal robot. The snow removal robot may include a sensor, the sensor may include the contact detectors, a plurality of contact detectors may be arranged in correspondence to different orientations, and the plurality of contact detectors may have one-to-one corresponding identity tags. The method for obstacle avoidance control in these embodiments may include:
receiving a detection signal from a sensor, where the sensor may include contact detectors, a plurality of contact detectors may be arranged in correspondence to different orientations, and the detection signal may include collision signals sent by the contact detectors;
retrieving sensor information, and retrieving sensor information corresponding to the contact detectors from the detection signal. The sensor information may include identity tags uniquely corresponding to the contact detectors; and
outputting an obstacle avoidance instruction, and outputting first obstacle avoidance instructions associated with the respective identity tags according to the identity tags.

Specifically, in some embodiments, implementation of steps of the method for obstacle avoidance control in these embodiments may include:
S1: establishing an instruction database.

In some embodiments, the instruction database may be established in advance. The instruction database may be configured to store the first obstacle avoidance instructions associated with the identity tags, and sensor orientation information associated with the identity tags, and the sensor orientation information may be configured to mark a relative orientation, relative to the snow removal robot, of corresponding contact detectors.

By establishing the instruction database, the identity tags and corresponding first obstacle avoidance instructions may be stored in association. By identifying the identity tags in the sensor information, the first obstacle avoidance instructions corresponding to the identity tags may be invoked from the database and output, a computation amount of the system may be reduced, and a rapid obstacle avoidance response ability of the apparatus may be improved.
S2: receiving a detection signal from a sensor. The sensor may include contact detectors, and the detection signal may include collision signals sent by the contact detectors.

The obstacle avoidance system may retrieve the corresponding identity tags after receiving the detection signal, and may output the corresponding first obstacle avoidance instructions according to the corresponding identity tags. According to different sensors, different obstacle avoidance instructions may be output, such that fine control at a plurality of angles may be implemented, and more accurate obstacle avoidance actions may be made according to the orientation of the obstacle.
S3: determining whether a signal type of the detection signal is the collision signal.

As an example, the obstacle avoidance system may determine that the received detection signal is the collision signal or a remote sensing signal. The collision signal may be an electrical signal and the remote sensing signal may be an electromagnetic wave signal. The electromagnetic wave signal may include a millimeter wave signal or a light wave, and the light wave may be configured to synthesize obstacle image information. If the detection signal is the collision signal, step S40 may be performed, and if the detection signal is the remote sensing signal, step S60 may be performed.

In this way, the contact detection device may be combined with the remote sensing detection device. When the contact detection device may detect the obstacle, the first obstacle avoidance instruction may be output, and the obstacle avoidance action corresponding to the first obstacle avoidance instruction may be performed. When the remote sensing detection device detects the obstacle, a second obstacle avoidance instruction may be output, and an obstacle avoidance action matching the second obstacle avoidance instruction may be performed. As long as one of the two obstacle avoidance systems works normally, the obstacle avoidance function may be implemented, and the reliability of the obstacle avoidance system may be improved. The contact detection device, as a safety measure, may prevent the robot body from being stuck in the obstacle and failing to travel when the signal of the remote sensing detection device is poor or the accuracy is reduced.
S4: retrieving sensor information, and retrieving sensor information corresponding to the contact detectors from the detection signal. The sensor information may include identity tags uniquely corresponding to the contact detectors. The identity tags may be numbers or models corresponding to the sensors.
S5: outputting the first obstacle avoidance instruction, the obstacle avoidance instruction matching the identity tag may be invoked from an instruction base according to the identity tag, and a drive system may be controlled to travel a predetermined distance in a specific direction.

The specific direction may be opposite the relative orientation. For example, when the obstacle avoidance system may detect that the orientation corresponding to the anti-collision sensor of the collision signal may be at a left side of the snow removal robot, the snow removal robot may be controlled to travel a predetermined distance rightwards, and then continues traveling around the obstacle. In this way, the obstacle avoidance system may be separated by a distance from the obstacle by controlling the drive system to travel the predetermined distance in a direction opposite the relative orientation of a corresponding sensor, and provide an activity space for bypassing the obstacle.
S6: outputting the second obstacle avoidance instruction. The second obstacle avoidance instruction may specifically include a travel path bypassing the obstacle may be generated according to the received remote sensing signal, and the snow removal robot may be controlled to travel along the path. The remote sensing sensor includes, but is not limited to, the millimeter wave radar, the camera, or the infrared sensor.

For the method for obstacle avoidance control, these embodiments further may provide a snow removal robot for running the method for obstacle avoidance control. The snow removal robot may include a robot body, an obstacle avoidance system, one or more processors, and a memory. The robot body may be configured to remove snow from a road. The obstacle avoidance system may be disposed on the robot body. The one or more programs may be stored in the memory and may be configured to be executed by the one or more processors, and the one or more programs may be configured to perform the method for obstacle avoidance control. In some embodiments, the obstacle avoidance system of the snow removal robot may include all the features or any combination of a plurality of features of the obstacle avoidance system in the embodiments, which is not repeated in these embodiments.

In the description of the present disclosure, some words are used to refer to specific components in the description and the claims, for example. It should be understood by those of ordinary skill in the art that hardware manufacturers may use different terms to refer to the same component. The description and the claims do not distinguish components by the difference of names, but by the difference of functions of the components. As mentioned through description and the claims, “comprise” and “include” are open terms, and should be interpreted as “comprise but is not limited to” and “include but is not limited to”; and “approximate” means that those of ordinary skill in the art may solve the technical problems within an error range and basically achieve the technical effects.

In the description of the present disclosure, it needs to be understood the orientation or positional relationships indicated by the terms “up,” “down,” “front,” “rear,” “left,” “right,” “inside,” etc. are based on the orientation or positional relationship shown in the accompanying drawings, are merely for facilitating the description of the present disclosure and simplifying the description, rather than indicating or implying that a device or element referred to must have a particular orientation or be constructed and operated in a particular orientation, and thus will not be interpreted as limitation to the present disclosure.

In the present disclosure, unless otherwise explicitly specified or defined, the terms such as “mounting,” “connecting,” “connection,” and “fixation” should be understood in a broad sense. For example, they may be a fixed connection, a detachable connection, or an integrated connection; a mechanical connection or an electric connection; a direct connection or an indirect connection through an intermediate medium; or internal communication of two elements or merely surface contact. For those of ordinary skill in the art, specific meanings of the above terms in the present disclosure may be understood according to specific circumstances.

In the explanation of the description, the explanation with reference to terms such as “an embodiment,” “some embodiments,” “examples,” “particular examples,” or “some examples” means that specific features, structures, materials, or characteristics described in combination with the embodiment or example are included in at least one embodiment or example of the present disclosure. In the description, illustrative expressions of the terms do not necessarily refer to the same embodiment or example. In addition, the specific features, structures, materials, or characteristics described may be combined in any one or more embodiments or examples in a suitable manner. In addition, those of ordinary skill in the art may combine and group different embodiments or examples and features in different embodiments or examples described in the description if there is no contradiction.

In addition, the terms such as “first” and “second” are used for descriptive purposes merely, and cannot be construed as indicating or implying relative importance or implicitly indicating the number of technical features indicated. Thus, the features defined with “first” and “second” may explicitly or implicitly include at least one of the features. In the description of the present disclosure, “plurality” indicates at least two, for example, two, three, etc., unless otherwise explicitly and specifically defined.

Finally, it should be noted that the embodiments described above are merely used for describing the technical solution of the present disclosure, rather than limiting the same. Although the present disclosure has been described in detail with reference to the foregoing embodiments, those of ordinary skill in the art should understand that the technical solution described in the foregoing embodiments may still be modified, or some technical features in the technical solution may be equivalently replaced. However, these modifications or replacements do not make the essence of a corresponding technical solution depart from the spirit and scope of the technical solution of the embodiments of the present disclosure.

1-39. (canceled)

40. A contact detector for a snow removal robot having a robot body and a working portion, the contact detector comprising:
a support component configured to be connected to an outer side of the working portion of the robot body;
a stationary contact component disposed on the support component; and
a movable contact component disposed on the support component, wherein:
in an absence of an external force applied to the support component, the movable contact component and the stationary contact component are spaced apart from each other,
the movable contact component is configured to move, in response to an external force applied to the support component, into electrical contact with the stationary contact component, and
the movable contact component is configured to separate from the stationary contact component, thereby breaking the electrical contact, when the external force is removed.

41. The contact detector according to claim 40, wherein:
the support component has a strip structure configured to extend around an outer contour of the working portion in a forward direction of the snow removal robot; and
at least one of the stationary contact component or the movable contact component extends in a length direction of the support component.

42. The contact detector according to claim 40, wherein:
the support component includes a stationary support portion and a movable support portion located at a side of the stationary support portion;
the movable support portion and the stationary support portion are spaced apart from each other;
the stationary contact component is disposed on the stationary support portion; and
the movable contact component is disposed on the movable support portion.

43. The contact detector according to claim 42, wherein:
the movable support portion comprises an elastically deformable structure;
the support component further includes an elastic return portion; and
the elastic return portion is connected between the movable support portion and the stationary support portion.

44. The contact detector according to claim 43, wherein:
the support component has a tubular structure defining a deformation space;
the movable support portion and the stationary support portion are arranged side-by-side and spaced apart from each other in a forward direction of the snow removal robot; and
the elastic return portion is connected between the movable support portion and the stationary support portion, such that the movable support portion, the stationary support portion, and the elastic return portion define the deformation space.

45. The contact detector according to claim 42, wherein:
the support component has a buffer cavity;
the stationary support portion includes an elastically deformable structure; and
the stationary support portion at least partially bounds the buffer cavity.

46. The contact detector according to claim 42, wherein:
the stationary contact component includes a stationary contact conductor disposed on the stationary support portion; and
the movable contact component includes a movable contact conductor disposed on the movable support portion.

47. The contact detector according to claim 46, wherein:
the stationary support portion is provided with an alignment recess on a side facing the movable support portion;
the stationary contact conductor protrudes from the side of the stationary support portion facing the movable support portion and is located in the alignment recess;
the movable contact conductor is spaced apart from the alignment recess; and
the movable contact conductor is configured to insert into the alignment recess when the movable contact component moves toward the stationary contact component in response to an external force applied to the support component.

48. The contact detector according to claim 46, wherein:
the stationary contact conductor is at least partially disposed in the stationary support portion and is at least partially located at a side of the stationary support portion facing the movable support portion; and
the movable contact conductor is at least partially disposed in the movable support portion and is at least partially located at a side of the movable support portion facing the stationary support portion.

49. The contact detector according to claim 46, wherein:
the support component includes an electrically insulating structure;
the contact detector further includes at least one of a stationary contact covering or a movable contact covering;
the stationary contact covering, when present, at least partially covers the side of the stationary support portion facing the movable support portion, at least partially covers the stationary contact conductor, and is electrically conductive; and
the movable contact covering, when present, at least partially covers the side of the movable support portion facing the stationary support portion, at least partially covers the movable contact conductor, and is electrically conductive.

50. The contact detector according to claim 49, wherein:
the support component further includes a connection portion connected to the movable support portion and the stationary support portion;
a joint between the connection portion and the stationary support portion is recessed in a direction facing away from the movable support portion and forms an auxiliary recess, the auxiliary recess including a first extension surface and a second extension surface opposite the first extension surface;
the movable contact covering extends towards the auxiliary recess and at least partially covers the first extension surface; and
the stationary contact covering extends towards the auxiliary recess and at least partially covers the second extension surface.

51. The contact detector according to claim 40, wherein the contact detector further includes an anti-collision frame configured to be connected to the robot body and extending around at least a portion of a perimeter of the working portion of the robot body, and the support component is disposed on the anti-collision frame.

52. The contact detector according to claim 51, wherein:
the anti-collision frame has a strip structure extending perpendicular to a forward direction of the snow removal robot; and
the support component extends in a length direction of the anti-collision frame, and is configured to be mounted on a side of the anti-collision frame facing away from the robot body.

53. The contact detector according to claim 52, wherein:
the anti-collision frame includes an anti-collision body portion and two anti-collision extension portions;
the two anti-collision extension portions are connected to two ends, in a length direction, of the anti-collision body portion, respectively, each anti-collision extension portion being bent relative to the anti-collision body portion such that the two anti-collision extension portions are spaced apart from each other; and
the support component is disposed on the anti-collision body portion and the two anti-collision extension portions, and is located on a side of the anti-collision frame facing away from the working portion.

54. The contact detector according to claim 51, wherein:
a first matching portion is at least partially disposed on the anti-collision frame;
a second matching portion is at least partially disposed on the support component; and
the first matching portion is connected to the second matching portion.

55. The contact detector according to claim 54, wherein:
the first matching portion includes a snap-fit recess in a side of the anti-collision frame facing the support component;
the second matching portion includes a snap-in protrusion disposed on a side of the support component facing the anti-collision frame; and
the snap-fit recess is configured to engage the snap-in protrusion.

56. The contact detector according to claim 51, wherein:
the contact detector further includes an extension frame extending in a vertical direction, the extension frame being connected to the anti-collision frame and configured to be connected to the robot body, and the extension frame being configured to support the anti-collision frame;
the working portion of the robot body includes a remote sensing detection device;
the extension frame includes a mounting position configured to mount the anti-collision frame, the mounting position and the working portion being spaced apart from each other in the vertical direction such that the anti-collision frame is located above the working portion and the remote sensing detection device, and the anti-collision frame is positioned outside a detection path of the remote sensing detection device;
the extension frame is hollow and includes a channel for wiring of the support component;
the contact detector further includes a junction box connected between the anti-collision frame and the robot body; and
the junction box includes a wire through-hole penetrating two opposite end faces of the junction box, the wire through-hole having two ports in communication with an interior of the anti-collision frame and an interior of the robot body, respectively.

57. An obstacle avoidance system for a snow removal robot having a robot body, the obstacle avoidance system comprising:
the contact detector according to claim 40;
a remote sensing detection device configured to be disposed at a side of a working portion of the robot body facing a forward direction of the snow removal robot; and
a controller disposed on the robot body, wherein the controller includes one or more processors and a memory, and the controller is configured to control the snow removal robot to adjust a movement path according to detection signals from the contact detector and the remote sensing detection device.

58. A snow removal robot, comprising:
a robot body configured to remove snow from a road; and
the obstacle avoidance system according to claim 57, wherein the obstacle avoidance system is disposed on or in the robot body.

59. A method for obstacle avoidance control for a snow removal robot having a robot body and a contact detector, the method comprising:
receiving a detection signal, wherein the detection signal includes a collision signal sent by the contact detector when a movable contact component of the contact detector moves into electrical contact with a stationary contact component of the contact detector in response to an external force;
reading sensor information from the detection signal, wherein the sensor information includes an identity tag uniquely corresponding to the contact detector; and
outputting an obstacle avoidance instruction to adjust a movement path of the snow removal robot, wherein outputting the obstacle avoidance instruction includes outputting a first obstacle avoidance instruction associated with the identity tag.
